(19) United States
(12) Patent Application Publication
(10) Pub. No.: US 2004/0136178 A1
(43) Pub. Date: Jul. 15, 2004

(54) Ear mounted flashlight

(76) Inventor: Sun Yu, Berkley, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/339,540

(22) Filed: Jan. 9, 2003

(51) Int. Cl. F21V 21/088

(52) U.S. Cl. 362/103; 362/191; 362/197; 362/396

(57) ABSTRACT

An ear mounted light contains a light source located within a housing adapted to contact a user ear. A manual switch selectively closes an electrical circuit between the light source and battery affording a lightweight light field projection that tracks with user head movement yet is not strapped to the user head.

### FIELD OF THE INVENTION

The present invention generally relates to hands-free lights, and in particular to a light retained in an operative position by engaging an ear of a user.

### BACKGROUND OF THE INVENTION

Hands-free lighting is required in a variety of settings. In spite of the need, prior art attempts to develop a hands-free light that is compact, adjustable and portable have met with only limited success. Book lights represent a class of prior art hands-free lights. U.S. Pat. No. 5,695,271 is representative of such a light. A typical book light clips or otherwise secures to a portion of the book, such as the cover or spine. While prior art book lights are well suited for use with a hardcover book, paperback books, loose papers and similar reading materials are poorly suited to support a book light. Additionally, the proximity of the book light to the page tends to create glare and, as a result, undue eyestrain.

Head mounted lights represent yet another class of hands-free lights. U.S. Published patent application 0024806 A1 is representative of these lights. Although a typical head light provides uniform illumination for a user at a reading distance and the light beam does track with head movement, the mounting of a headlamp with a strap messes a user's hair, is constraining, and not considered a fashionable apparel accessory. Specialized headlamps such as those shown in U.S. Pat. Nos. 4,631,646 and 4,945,458 are integrated into complex headgear structures that are heavy and often have a distant power source such as a waist belt, battery pack, or line power delivered by way of a cord.

The prior art attempts to create a lightweight hands-free flashlight that is well suited for reading have met with limited success. Thus, there exists a need for a hands-free flashlight that tracks with a user's head movement yet need not be strapped to a user's head.

### SUMMARY OF THE INVENTION

A light is described that is mounted on a user ear. The light has a housing containing a light source. The housing is adapted to hang in contact with the user ear. A manual switch selectively closes an electrical circuit between the light source and a battery. A light emitting diode represents a preferred light source. The majority of the inventive device light source emission is intended to project into the visual field of a user for reading and other close work purposes.

A light housing in one embodiment is configured into a base portion and a terminal appendage with a light emitting diode light source located within the terminal appendage. An ear clip attached to the base portion of the housing rests over the ear of a user and retains the housing in contact with the ear of the user.

In another embodiment, the housing is contoured to simultaneously contact at least three points of the ear of a user and hang from the ear. The housing has a forward facing surface from which a light source generates illumination.

### BRIEF DESCRIPTION OF THE DRAWINGS

FIG. 1 is a perspective view of an inventive light being worn by a user;

FIG. 2 is an exploded planar view of the inventive light depicted in FIG. 1;

FIG. 3 is an exploded, partial cut-away perspective view of the inventive light depicted in FIG. 1;

FIG. 4 is an inner planar view of a portion of the inventive light depicted in FIG. 1, illustrating the attachment between an ear clip and housing;

FIG. 5 is a perspective expanded view of a light source from the inventive light depicted in FIG. 1;

FIG. 6 is a planar view of another embodiment of an inventive light;

FIG. 7 is an alternate embodiment of an inventive light where FIG. 7A is a perspective view, FIG. 7B is a planar view, and FIG. 7C is a frontal view; and

FIG. 8 is a perspective view of still another embodiment of an inventive light as mounted to a user ear.

### DETAILED DESCRIPTION OF THE PREFERRED EMBODIMENTS

The present invention has utility as a hands-free flashlight. The present invention affords the desirable characteristics of being lightweight and having a light beam that moves with a user's head movement, without resort to head straps or incorporation into a glasses frame. Instead, the present invention hangs the flashlight over and in contact with a user's ear. An inventive ear mounted flashlight is particularly well suited for the activities of reading, preparing and installing equipment in the field, and walking under low ambient light conditions.

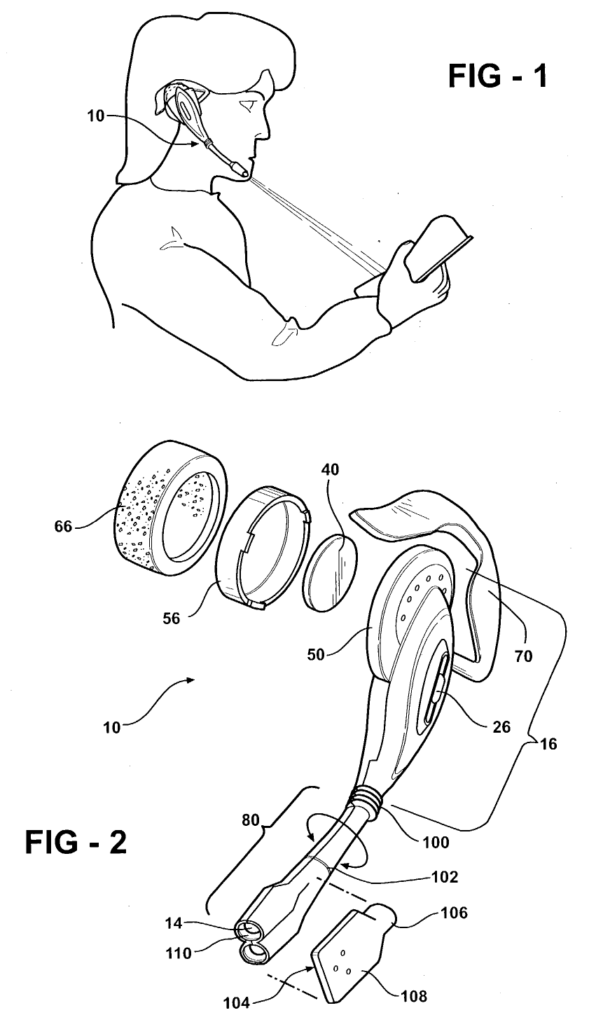

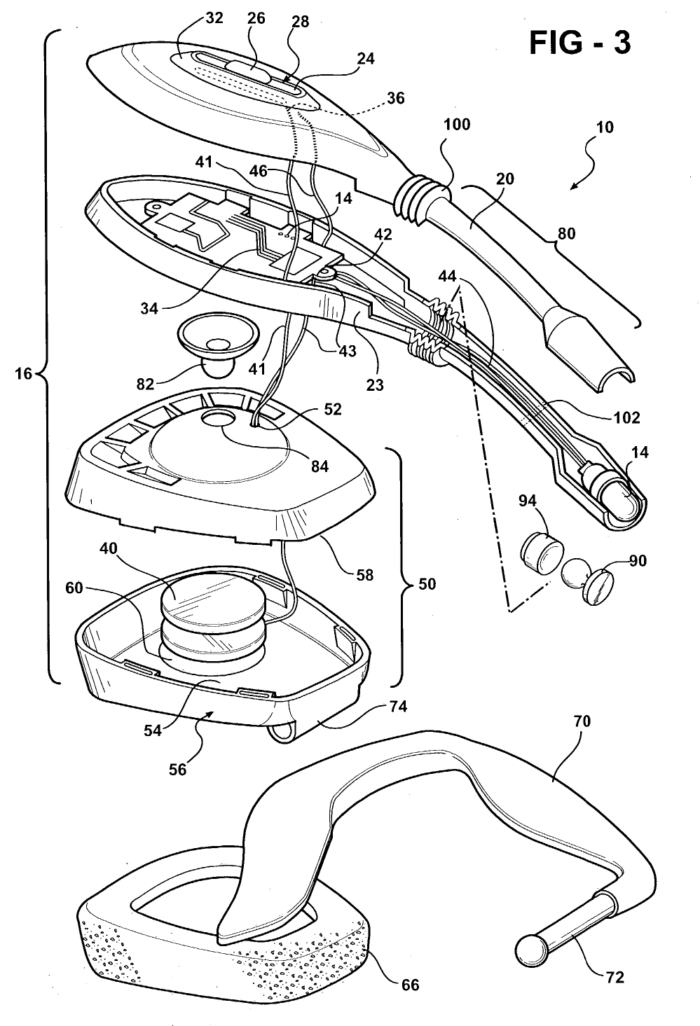

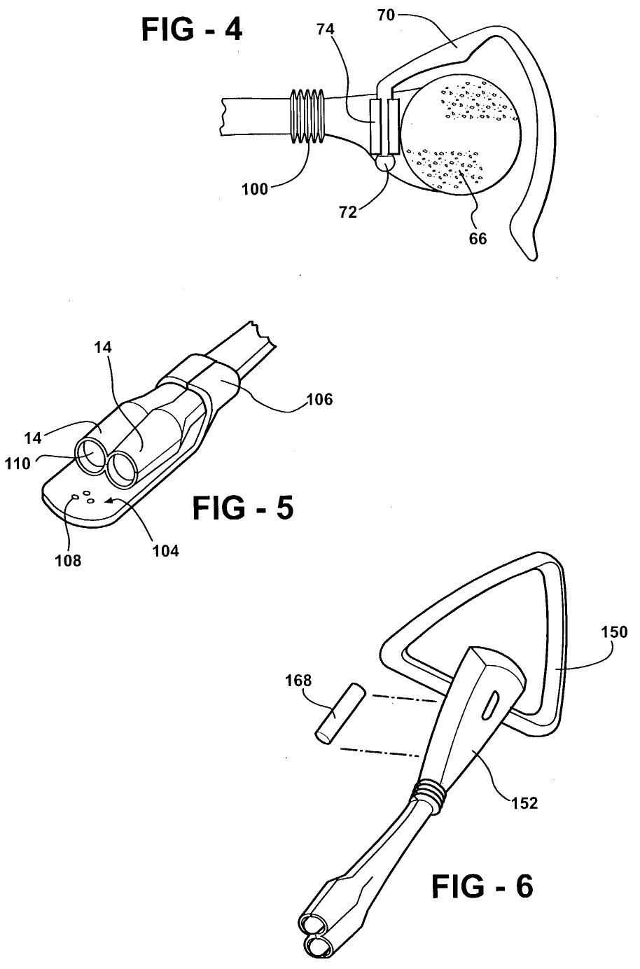

With reference now to FIGS. 1-5, the overall inventive light mounted to a user ear is shown generally at 10. A light source 14 is partly enclosed within a housing shown generally at 16. In a preferred embodiment, the light source is a light emitting diode. More preferably, the light source includes multiple proximal light emitting diodes. The LEDs are appreciated to be of any visible color illustratively including red, yellow, blue and white. The housing 16 has an outer panel 20 having an aperture 24. The aperture 24 is adapted to receive the boss portion 26 of a switch generally shown at 28. The boss 26 extending from switch 28 protrudes through aperture 24 of the outer panel 20. The boss 26 slides within aperture 24 with the application of lateral pressure to the boss. The switch 28 has a pedestal 32 extending beneath the boss 26 adapted to retain the boss 26 within the flashlight 10. The pedestal 32 is adapted to engage enclosing rails 34 of the outer panel 20. A leaf spring contact 36 attached to the switch 28 is connected to one terminal of a battery 40 and one terminal of the light source 14. In a preferred embodiment, the switch 28 is devoted to the activation of the light source 14 and thereby operable independent of optional device components. Lateral movement of the switch 28 urges the leaf spring contact 36 into electrical communication with a conductive post 42. The conductive post 42 being electrically coupled to an opposing battery terminal 44 and an opposing light source terminal 46. The housing 16 also has a battery compartment 50. The battery compartment 50 includes a battery terminus (not shown) mounted therein and connected to battery lead 41 by way of an aperture 52. The battery compartment 50 has an interior wall 54 adapted to receive a battery 40. In a preferred embodiment where the light source is an LED, the battery is a two-battery stack of lithium button-type batteries. The battery 40 is retained within the battery housing 50 by a cap 56 adapted to secure against the other face 58 of the battery housing 50. The battery housing cap 56 is in electrical communication with the conductive post 42 by way of an electrical contact on the interior face 60 of the cap 56. A battery 40 upon being enclosed within the battery housing 50 and the battery housing cap 56 completes a circuit with the switch 28 upon movement of the switch 28 to bring leaf spring 36 into contact with conductor post 42 so as to illuminate the light source 14. As the battery housing cap 56 rests against the outward surface of a user ear, the exterior surface 62 of the battery housing cap 56 is preferably at least partially covered with a foam cushion 66.

In the inventive embodiment depicted in FIGS. 1-5, an ear clip 70 is attached to the housing 16. The ear clip 70 is adapted to rest over a user ear. The ear clip 70 contacts the user ear above and behind the ear which, together with the contact point of the cushion 66 and underlying cap 56 of the housing 16, creates an enveloping three point contact between the inventive light and the user ear. The ear clip 70 has a terminal post portion 72 mateable to an ear clip snap attachment 74 located on the battery compartment 50. The pivotal attachment of an ear clip 70 to the cap 56 affords a user a customizable and natural positioning of the inventive light relative to the user ear. It is appreciated that the inventive ear clip need not drape over and behind a user ear but rather is able to form a three point contact with a user ear by fitting over the ear, behind the ear and simultaneously engaging the earlobe. With a three contact point ear clip, it is appreciated that the housing need not contact the outward surface of the user ear. The inventive embodiment depicted in FIG. 6 is representative of such an ear clip design, with a pivot between the ear clip 150 and the housing 152 affording a customizable and comfortable user fit and otherwise has like components to those detailed with respect to FIGS. 1-5.

In the inventive embodiment depicted in FIGS. 1-5, the housing 16 is extended to form a terminal appendage 80 to extend the light source 14 forward from the vicinity of a user ear to approximately the forward position of the user eyes. Preferably, the terminal appendage 84 has at least one angular degree of freedom to facilitate illumination from an inventive light with a user field of view. The inventive embodiment depicted in FIGS. 1-5 has multiple alignment points for adjustment of illumination position. Optionally, the outer panel 20 of the housing 16 secures to the battery compartment 50 by way of a pivot pin 82 secured in rotational alignment with a complementary fitting 84 in the battery compartment 50. It is appreciated that the ability to rotate the outer panel 180 degrees relative to the battery compartment 50, coupled with the ability to disengage the terminal post portion 72 of the ear clip 70 from the ear clip snap attachment 74 and reengage the terminal post portion in an opposite orientation relative to the snap attachment 74, makes the inventive embodiment depicted in FIGS. 1-5 suitable for engaging either the right or left ear of a user.

Preferably, a universal joint 90 joins the terminal appendage 80 with the remainder of the housing. It is appreciated that any number of conventional joints are operative herein, illustratively including ball, swivel and hinge joints. Upon securing the joint receptacle 94 relative to the inner panel 23 and outer panel 20, the terminal appendage 80 extending from the universal joint 90 is movable relative to the receptacle 94. It is appreciated that a pair of orthogonal pivot joints (not shown) yield a comparable two-dimensional movement of a terminal appendage relative to other portions of the inventive housing. A rubberized boot 100 overlies the joint 90. Optionally, a swivel joint 102 intermediate between the joint 90 and the light source 14 affords rotation about a central axis to further control illumination direction spread. Optionally, a slidable light shield 104 engages the exterior of the terminal appendage 80. The light shield 104 has a collar portion 106 adapted to engage the exterior of the terminal appendage 80. Extending from the collar portion 106 is a panel extension 108 adapted to modify the light source projection shape. Optionally, a lens 110 is placed within the optical path of emission from the light source 14. The lens 110 is formed of any optically clear plastic or glass material having wear characteristics suitable for usage in a personal setting. It is appreciated that a lens 110 has any number of geometries illustratively including concave, convex and toroidal. The choice of lens properties is dependent upon whether emission from the light source 14 is to be collimated or diffused.

Optionally, an inventive light 10 incorporates components conventional to a telecommunications headset. These components illustratively include a terminal appendage microphone, a speaker proximal to the user ear, and an external power source adaptor fitting to selectively power the light source.

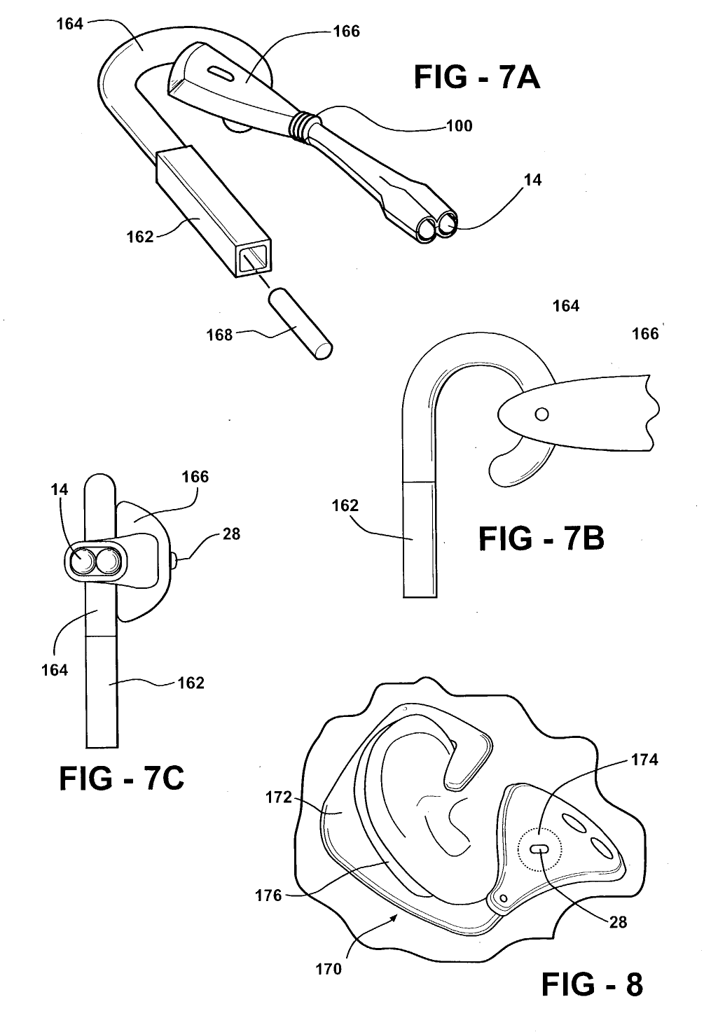

Referring now to FIG. 7, an alternate embodiment of an inventive light is shown generally at 160. While the functional interior components of the light 160 correspond to those described with respect to FIGS. 1-5, the light 160 has a battery housing 162 attached to an ear clip 164. A housing 166 is pivotally attached to the ear clip 164. The housing 166 is positioned generally over the exterior surface of the user ear. Preferably, a cylindrical battery 168 secures within the battery housing 162. A cylindrical battery 168 such as a AAA, AA or metal hydride battery is appreciated to be more readily available and cost effective to replace than button-type batteries and as such makes the light 160 amenable to battery replacement. The weight of the battery 168 located below and behind a user ear tends to pull the hanging ear clip 164 into the space between a user ear and the user's head so as to keep the light in place. The light 160 has a switch, joints and light source as described with respect to FIGS. 1-5. It is appreciated that optional components such as a light shield, swivel and light source lens as detailed with respect to FIGS. 1-5 are also operative with this embodiment.

Referring now to FIG. 8, a light is shown generally at 170. The light 170 has a unitary housing that envelopes a user ear and thereby secures the inventive light 170 to the user. The light 170 contains an internal battery compartment 172 forward of the user ear. Preferably, the battery is a button-type battery. The switch, light source and wiring within the light 170 corresponds to that described with respect to FIGS. 1-5 and accordingly are given like numbers. The switch 28 of light 170 preferably overlies the battery compartment 172. Preferably, the ear contacting surface 176 of the housing 172 is layered with a cushion material 176. The cushion material 176 being attached to the housing 172 by conventional means illustratively including contact adhesive.

The foregoing description is illustrative of particular embodiments of the invention, but is not meant to be a limitation upon the practice thereof. The following claims, including all equivalents thereof, are intended to define the scope of the invention.

1. A light mounted on a user ear comprising:
a light source;
a battery;
a manual switch selectively closing an electrical circuit between said light source and said battery; and
a housing containing said light source and adapted to hang in contact from the user ear.

2. The light of claim 1 further comprising an ear clip attached to said housing and adapted to rest over the user ear.

3. The light of claim 2 wherein said ear clip pivots relative to said housing.

4. The light of claim 1 wherein said battery is located within said ear clip.

5. The light of claim 1 wherein said battery is located within said housing.

6. The light of claim 1 wherein said battery is selected from the group consisting of: AAA, AA and button-type batteries.

7. The light of claim 1 further comprising a first joint located within said housing to form a terminal appendage having said light source therein.

8. The light of claim 7 further comprising a second joint intermediate between said first joint and said light source.

9. The light of claim 7 wherein said first joint is selected from a group consisting of ball, swivel and hinge.

10. The light of claim 1 further comprising an adjustable light shield adapted to engage said housing proximal to said light source.

11. The light of claim 1 wherein said light source is a light emitting diode.

12. The light of claim 7 further comprising a microphone within the terminal appendage and a speaker within said housing in overlying proximity with the user ear.

13. The light of claim 1 further comprising an external power source adaptor coupling fitting located within said housing.

14. The light of claim 1 further comprising a cushion intermediate between said housing and the user ear.

15. A light mounted on a user ear comprising:
a light emitting diode;
a battery;
a manual switch selectively closing an electrical circuit between said light source and said battery;
a housing having a base portion and a terminal appendage, said light emitting diode located within the terminal appendage; and
an ear clip attached to the base portion of said housing, said ear clip adapted to rest over the user ear.

16. The light of claim 15 further comprising a joint intermediate between the base portion and the terminal appendage of said housing.

17. The light of claim 15 wherein said ear clip is movable relative to said housing.

18. The light of claim 15 wherein said housing and said ear clip together have at least three points of contact with the user ear.

19. The light of claim 15 wherein said terminal appendage is bendable.

20. The light of claim 15 further comprising a second light emitting diode that is part of said electrical circuit upon closing of said manual switch.

21. The light of claim 15 wherein said battery is located within said ear clip.

22. The light of claim 15 wherein said battery is located within said housing.

23. The light of claim 15 wherein said battery is selected from the group consisting of: AAA, AA and button-type batteries.

24. The light of claim 16 wherein said first joint is selected from a group consisting of ball, swivel and hinge.

25. The light of claim 16 further comprising an adjustable light shield adapted to engage said housing proximal to said light source.

26. The light of claim 16 further comprising a microphone within the terminal appendage and a speaker within said housing in overlying proximity with the user ear.

27. The light of claim 16 further comprising a cushion intermediate between said housing and the user ear.

28. A light mounted on a user ear comprising:
a light emitting diode;
a battery;
a manual switch selectively closing an electrical circuit between said light source and said battery; and
a housing contoured to simultaneously contact at least three points of the user ear and hang therefrom, said housing having a forward facing surface, the forward facing surface having said light emitting diode projecting therefrom.

29. The light source of claim 28 further comprising a joint intermediate between the forward facing surface and a housing base portion.

30. The light of claim 28 wherein said battery is located within said housing in underlying proximity with said switch.

31. The light of claim 28 wherein said battery is a button-type battery.

32. The light of claim 28 wherein the front surface is bendable.
